(19) United States
(12) Patent Application Publication
(10) Pub. No.: US 2024/0315331 A1
(43) Pub. Date: Sep. 26, 2024

(54) ADULT TOY WITH VAPING DEVICE

(71) Applicant: MAIA TOYS LLC, HOUSTON, TX (US)

(72) Inventor: May Chan, Houston, TX (US)

(73) Assignee: MAIA TOYS LLC, HOUSTON, TX (US)

(21) Appl. No.: 18/306,452

(22) Filed: Apr. 25, 2023

Related U.S. Application Data
(60) Provisional application No. 63/454,412, filed on Mar. 24, 2023.

(51) Int. Cl. A24F 40/42; A24F 40/50; A24F 40/95; A61H 19/00; A61H 23/02

(52) U.S. Cl. CPC A24F 40/42; A24F 40/50; A24F 40/95; A61H 19/00; A61H 23/02; A61H 2201/169

(57) ABSTRACT

An adult vaping device that can include a housing having an first portion and a second portion, a vaping system disposed within the housing, toward the first portion of the housing, a vibration mechanism disposed within the housing, toward the second portion of the housing, a power source disposed within the housing and electrically connected to the vibration mechanism and the vaping system, an outer contact layer disposed about the housing, and a cap removably connected to the first portion of the housing, adjacent the vaping system. The vaping system can include a receptacle for receiving a vaping cartridge. The power source can selectively provide power to the vaping system and/or the vibration mechanism. The outer contact layer can cover the housing. The cap can allow access to the cartridge receptacle formed within the vaping system. The vibration mechanism and the vaping system can operate independently or simultaneously.

### CROSS-REFERENCE TO RELATED APPLICATION

This application claims priority to U.S. Provisional Patent Application No. 63/454,412, filed on Mar. 24, 2023, which is incorporated by reference herein.

### FIELD

Embodiments described generally relate to adult toys. More specifically, embodiments described relate to adult sex toys with a vaping device and methods for using same.

### BACKGROUND

The adult toy industry has a long history of creating tools, devices, and toys intended to enhance, improve, and increase sexual pleasure. Adult toys are frequently designed around entirely new experiences. However, adult toys are only effective when they are able to offer an improved experience during sexual activities in addition to the new experience.

Vaping is the next technological improvement in recreational smoking activities. Vape pens and other devices are desirable for their compact size and portability, providing users with a wide range of inhalable or smokable products. Vaping is frequently paired with recreational, social, and otherwise pleasurable activities to enhance a user's experience. However, vaping requires its own specific equipment to be carried and used that is separate from any non-vaping activity. As a result, vaping typically interrupts or stops other activities from occurring while the user vapes.

There is a need, therefore, for an adult toy that provides an improved sexual experience through the alternation of sexual stimulation and vaping during intercourse.

### SUMMARY

An adult vaping device that can include a housing having an first portion and a second portion, a vaping system disposed within the housing, toward the first portion of the housing, a vibration mechanism disposed within the housing, toward the second portion of the housing, a power source disposed within the housing and electrically connected to the vibration mechanism and the vaping system, an outer contact layer disposed about the housing, and a cap removably connected to the first portion of the housing, adjacent the vaping system, according to one or more embodiments is provided. The vaping system can include a receptacle for receiving a vaping cartridge. The power source can selectively provide power to the vaping system and/or the vibration mechanism. The outer contact layer can cover the housing. The cap can allow access to the cartridge receptacle formed within the vaping system. The vibration mechanism and the vaping system can operate independently or simultaneously.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are, therefore, not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1 depicts an illustrative front plan view of an adult toy vaping device, according to one or more embodiments described herein.

FIG. 2 depicts an exploded schematic view of the adult toy vaping device depicted in FIG. 1, according to one or more embodiments described herein.

FIG. 3 depicts an illustrative cross-section view of the adult toy vaping device depicted in FIGS. 1 and 2, according to one or more embodiments described herein.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Language of degree used herein, such as the terms “approximately,” “about,” “generally,” and “substantially” as used herein represent a value, amount, or characteristic close to the stated value, amount, or characteristic that still performs a desired function or achieves a desired result.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “a clamp” include embodiments where one, two, or more clamps are used, unless specified to the contrary or the context clearly indicates that only one clamp is used.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions or examples, which are included to enable a person having ordinary skill in the art to make and use the inventions, when the information in this disclosure is combined with publicly available information and technology.

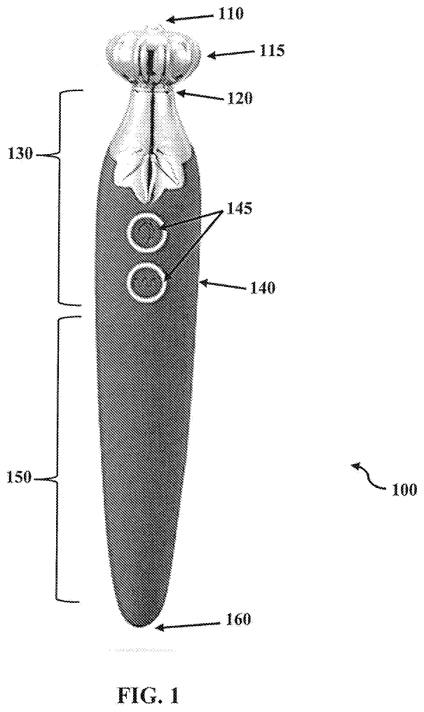

FIG. 1 depicts an illustrative front plan view of an adult toy vaping device 100, according to one or more embodiments. The device 100 can include a first end 110, a cap 115, a neck 120, a first portion 130, a body 140, one or more control buttons 145, a second portion 150, and a second end 160. The body 140 includes the first end 110 that can be disposed proximate the first portion 130 that can be proximate the second portion 150 that can be proximate the second end 160. As used herein, the term “end” refers to the most extreme surface of the body 140. Depending on the orientation of the device 100, the first end 110 can be the upper end, left end, right end or bottom end. Likewise, depending on the orientation of the device 100, the second end 160 can be the upper end, left end, right end or bottom end. Regardless of orientation, however, the first end 110 will be the opposite of the second end 160.

The first portion 130 can be located adjacent the first end 110, and the second portion 150 can be located adjacent the second end 160. The respective lengths of the first portion 130 (“L1”) and the second portion 150 (“L2”) can be the same. The respective lengths of the first portion 130 (“L1”) and the second portion 150 (“L2”) can be different. For example, L1 can be equal L2 (e.g., L1=L2); L1 can be less than L2 (e.g., L1<L2); or L1 can be greater than L2 (e.g., L1>L2). The first portion 130 and the second portion 150 can abut one another and define the longitudinal axis of the body 140.

The body 140 can have any suitable shape and size. For example, the body 140 can be tapered, conical, wedge-like, or have a carrot-like silhouette, or any other shape/silhouette in which the outer diameter or surface of the body 140 generally tapers (i.e., generally decreases) from its first portion 130 toward its second end 160.

The cap 115 can be removably attached to the body 140, proximate the first end 110 thereof. The cap 115 can have a series of spiral or helical threads formed on an outer portion thereof that can mate and engage matching spiral or helical threads formed on an inner surface of the neck 120. The cap 115 also can be removable attached to the body 140 using a friction fit, clamps, magnets, or other mechanisms for attachment. The neck 120 can be located near, or the first portion 130 of the body 140. The neck 120 can be configured to receive the cap 115 using screw threads, friction fit, clamps, magnets, or other mechanisms for attachment. When attached to the body 140, the removeable cap 115 can cover or otherwise conceal its mechanisms for attachment to the body 140, such screw threads, friction fit, clamps, magnets, or the other mechanisms for the same. When the removeable cap 115 attaches to the body 140, the first end 110 can be located at the outermost end of the cap 115.

The one or more control buttons 145 can be located on the first portion 130 of the body 140 or on the second portion 150, or any combination thereof. The one or more control buttons 145 can be push buttons or toggle switches and can be used to turn power to the device 100 on and off.

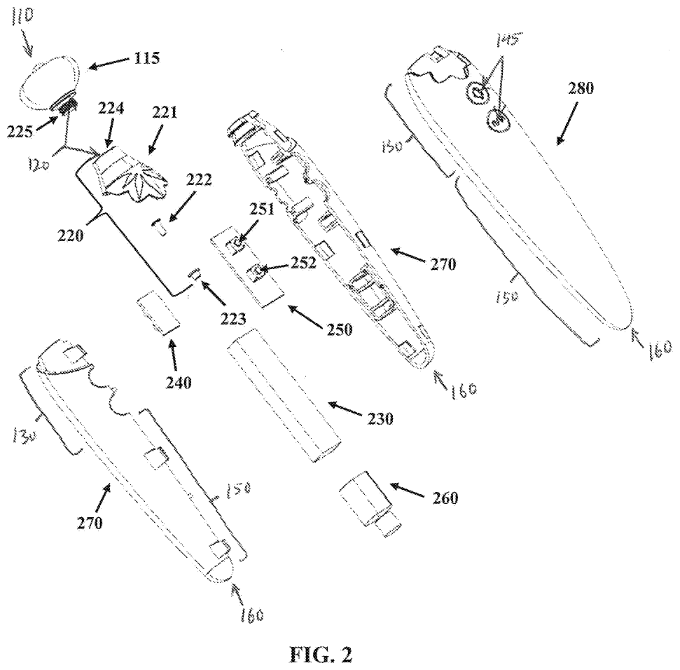

FIG. 2 depicts an exploded schematic representation of the device 100, according to one or more embodiments. As shown, the device 100 can further include a vaping system 220, a power source 230, a charging port 240, a circuit board 250, a vibration system 260, an inner support structure 270, and an outer contact layer 280. The vaping system 220 can further include a negative contact 221, a positive contact 222, and an electrical insulator 223. The circuit board 250 can include a vape on/off control button 251 and a vibrator on/off control button 252.

Considering the cap 115 in more detail, the cap 115 can be removably attached to one end of the vaping system 220 to prevent dust, dirt, hair, debris, liquids, and/or other contaminants, or any combination thereof, from entering the vaping system 220. The cap 115 can be made of one or more plastics, metals, or any other suitable material, or any combination thereof. The cap 115 can be any decorative or ornamental shape or design. In one or more embodiments, the cap 115 can have a decorative shape that resembles a flower, crown, star, or the like. In one or more embodiments, the cap 115 can include a plurality of cap threads 225 configured to removably attach the cap 115 to the neck 120. In one or more embodiments, the plurality of cap threads 225 on or about the cap 115 can include right-handed or left-handed threads.

Considering the neck 120 in more detail, the neck 120 can be or can include at least a portion of the receptacle 224. The receptacle 224 can be configured to engage the cap 115 or a vape cartridge (not shown) using screw threads, friction fit, clamps, magnets, or other mechanisms for attachment. In one or more embodiments, the receptacle 224 can include right-handed or left-handed threads. A vape cartridge (not shown) can slide freely in and out of the receptacle 224 or a vape cartridge can be removably attached to the receptacle 224 using any one or more of the following: screw threads, friction fit, clamps, magnets, and other known mechanisms for attachment.

The vaping system 220 can include the neck 120 and receptacle 224. The vaping system 220 can be configured to receive various vape cartridge designs that can operate at one or more power settings. In one or more embodiments, the vaping system 220 can be configured to receive a vape cartridge that can operate at a pre-heat, low, medium, and/or high power setting. In one or more embodiments, the vaping system 220 can be configured to receive 510 Thread, PAX Pods™, Stiizy™, CCELL™, DART SERIES™, and the like. In one or more embodiments, the vape cartridge can include right-handed or left-handed threads.

The electrical insulator 223 can be located in physical or electrical contact with the resistive heating element. The electrical insulator 223 can be configured to physically and/or electrically isolate both the negative contact 221 and the positive contact 222 from other components in the device 100, such as the power source 230, charging port 240, vibration system 260, and the like, or any combination thereof. The electrical insulator 223 can be made of one or more plastics, rubbers, or any other suitable non-conductive material, or any combination thereof. The electrical insulator 223 can be used to isolate power to the vaping system 220 independent of the vibration system 260 and vice versa.

The power source 230 can include any one or more batteries or other power storage components configured to receive, store, and/or provide power. The power source 230 can include lead-acid, nickel-cadmium, nickel-metal hydride, lithium-ion, or any other suitable rechargeable battery, or any combination thereof. The power source 230 can be configured to provide electrical power to the vaping system 220, the circuit board 250, and/or the vibration system 260. The power source 230 can be configured to receive and store electrical power delivered from the charging port 240. In one or more embodiments, the power source 230 can be a rechargeable lithium-ion battery that can maintain power for the vaping system 220 and/or vibration system 260 for at least 8 minutes, 10 minutes, 12 minutes, 27 minutes, 30 minutes, or 33 minutes, or longer. In one or more embodiments, the power source 230 can be configured to provide electrical power to the vaping system 220 through the circuit board 250. In one or more embodiments, the power source 230 can be configured to provide electrical power to the vibration system 260 through the circuit board 250. In one or more embodiments, the power source 230 can be configured to provide electrical power to the vaping system 220 and the vibration system 260 at the same time through the circuit board 250 to allow for at or near simultaneous operation of both the vaping system 220 and the vibration system 260.

The charging port 240 can include an electrical connection configured to receive a charging cable (not shown). The charging port 240 can be configured to receive the charging cable by using screw threads, friction fit, clamps, magnets, or other mechanisms for attachment. The charging cable can include a USB-A, USB-B, USB-C, USB-Mini, Micro-USB, Lightning Charger™, and the like, or any combination thereof, for receiving power from a suitable external power source. In one or more embodiments, the charging port 240 can be configured to receive a USB-A charging cable that can magnetically attach to the charging port 240.

The circuit board 250 can include a vaping memory, a vibrating memory, a clock, and any suitable circuit components for sending and/or receiving signals throughout the device 100. The vaping memory can include instructions to interpret signals from the vape control button 251 in order to control the vaping system 220. The vaping memory instructions can include interpreting one or more vape control button 251 presses by a user to set the one or more power settings of the vape system 220. In one or more embodiments, the vape control button 251 can be pressed one time to cycle the vape system 220 power settings between pre-heat, low, medium, high, and/or off. In one or more embodiments, the vape control button 251 can be pressed two times to set the power setting to pre-heat, pressed three times to cycle the power setting between low, medium, and/or high, and/or pressed five times to set the power setting on and/or off, and/or any combination thereof. The vibrating memory can include instructions to interpret signals from the vibrator control button 252 in order to control the vibrating system 260. The vibrating memory instructions can include interpreting one or more vibrator control button 252 presses by the user to set one or more vibrator settings of the vibration system 260. In one or more embodiments, the vibrator control button 252 can be pressed one time to cycle the vibration system 260 between one or more vibrator settings and/or set the vibration system 260 on and/or off, and/or any combination thereof. In one or more embodiments, the vaping memory instructions can include automatically powering off the vaping system 220 after at least 3 minutes, 5 minutes, 8 minutes, 10 minutes, 15 minutes, or 20 minutes, or longer, in order to prevent overheating, damaging the device 100, injuring the user, and the like, or any combination thereof.

The vibration system 260 can include a motor configured to vibrate the device 100. The vibration system 260 can include one or more vibrator settings that can include individual, intermittent, and/or sustained pulses, shifts, shakes, vibrations, jerks, throbs, oscillations, beats, and/or the like, and/or any combination thereof. The vibration system 260 can be set to one or more speeds, rhythms, tempos, and/or the like, and/or any combination thereof. The vibration system 260 can be configured to receive the signals from the vibrating memory within the circuit board 250.

The inner support structure 270 can include inflexible columns, struts, casings, supports, brackets, compartments, housings, cavities, members, and/or the like, and/or any combination thereof. The inner support structure 270 can be configured to suitably support and/or protect the cap 115, the vaping system 220, the power source 230, the charging port 240, the circuit board 250, and/or the vibration system 260. The inner support structure 270 can be made of one or more plastics, metals, and/or any other suitable material, and/or any combination thereof. In one or more embodiments, the inner support structure 270 can be configured to be disassemblable and/or provide for the removal, exchange, replacement, and/or the like, and/or any combination thereof of any one or more device 100 component, to include but not limited to the cap 115, the vaping system 220, the power source 230, the charging port 240, the circuit board 250, the vibration system 260, and/or the like, and/or any combination thereof. In one or more embodiments, the inner support structure 270 can be configured to prevent fluid and/or other contaminants from reaching any one or more device 100 component. The inner support structure 270 can be configured to have a first portion 130 and a second portion 150. In one or more embodiments, the inner support structure 270 can be configured to house the vaping system 220 at or near the first portion 130 of the inner support structure 270 and the vibration system 260 at or near the second portion 150 of the inner support structure 270.

The outer contact layer 280 can include flexible skins, layers, sheaths, membranes, shells, coverings, and/or the like, and/or any combination thereof. The outer contact layer 280 can be suitable for direct and/or indirect contact with the user's and/or the user's partner's genitalia, orifices, skin, and/or the like, and/or any combination thereof. The outer contact layer 280 can be configured for the purpose of massaging, stimulating, relaxing, sexually gratifying, and/or the like, and/or any combination thereof, the user and/or the user's partner. In one or more embodiments, the outer contact layer 280 can include bumps, ridges, undulations, fingers, frills, and/or the like, and/or any combination thereof, and can include smooth, rough, and/or other texturing. The outer contact layer 280 can be made of one or more plastics, rubbers, silicone, and/or any other suitable material, and/or any combination thereof. In one or more embodiments, the outer contact layer 280 can be impermeable and configured to be washable with one or more soaps, disinfectants, and/or the like. The outer contact layer 280 can be configured to attach to, wrap around, envelope, cover, and/or the like, and/or any combination thereof, some or all of the body 140. In one or more embodiments, the outer contact layer 280 can be configured to cover all or essentially all of the inner support structure 270. In one or more embodiments, the outer contact layer 280 can be configured to cover a portion of the inner support structure 270 and can allow external access to other components such as the cap 115, the vaping system 220, the power source 230, the charging port 240, and/or the like, and/or any combination thereof. In one or more embodiments, the outer contact layer 280 can be configured to not cover a first portion 130 of the inner support structure 270 where the vaping system 220 can be located, but can be configured to cover a second portion 150 of the inner support structure 270 where the vibration system 260 can be located.

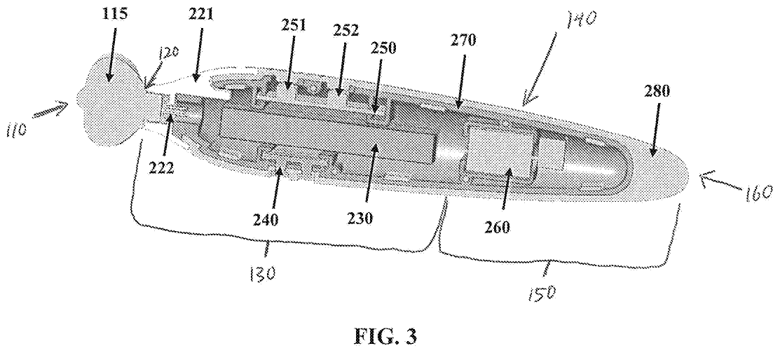

FIG. 3 depicts an illustrative cross-section view of the device 100, according to one or more embodiments. In one or more embodiments, the device 100 can be used by the user to massage, stimulate, relax, sexually gratify, and/or any combination thereof, the user's and/or the user's partner's genitalia, orifices, skin, and/or the like, and/or any combination thereof. In one or more embodiments, the device 100 can be used by the user to smoke, inhale, vape, and/or the like, one or more vape cartridges selected by the user. In one or more embodiments, the device 100 can be used to only sexually stimulate the user or the user's partner. In one or more embodiments, the device 100 can be used to only vape. In one or more embodiments, the device 100 can be used to simultaneously sexually stimulate the user's partner and be used to vape.

Additional aspects of the present disclosure include the following embodiments.

Embodiment I: An adult vaping device, comprising a housing having a first portion and a second portion; a vaping system disposed within the housing, toward the first portion of the housing, wherein the vaping system includes a receptacle formed within the first portion of the housing for receiving a vaping cartridge; a vibration mechanism disposed within the housing, toward the second portion of the housing; a power source disposed within the housing and electrically connected to the vibration mechanism and the vaping system, the power source configured to selectively provide power to the vaping system and/or the vibration mechanism, an outer contact layer disposed about the housing, the outer contact layer configured to cover the housing; and a cap removably connected to the first portion of the housing, adjacent the vaping system, the cap configured to allow access to the cartridge receptacle formed within the vaping system, wherein the vibration mechanism and the vaping system are configured to operate independently or simultaneously.

Embodiment II: The device according to Embodiment I, wherein the power source is a rechargeable battery.

Embodiment III: The device according to Embodiment I or II, further comprising an inner support structure within the housing, the inner support structure having a charging port configured to provide external power to the power source.

Embodiment IV: The device according to Embodiment III, wherein the charging port comprises a magnet to attach a USB-B charging cable.

Embodiment V: The device according to any of Embodiments I through IV, wherein the vaping system comprises one or more threads formed on an inner surface thereof and is configured to receive threaded vaping cartridges.

Embodiment VI: The device according to any of Embodiments I through V, wherein the vaping system is configured to have a low, medium, and high power setting when operated.

Embodiment VII: The device according to any of Embodiments I through VI, wherein the vibration mechanism is configured to have a plurality of vibration settings when operated.

Embodiment VIII: The device according to any of Embodiments I through VII, wherein the outer contact layer is made of flexible silicon.

Embodiment IX: The device according to any of Embodiments I through VIII, wherein the vibration mechanism and the vaping system are controlled by electrically isolated control buttons so the vibration mechanism can be operated independently or simultaneously with the vaping system.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof can be determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An adult vaping device, comprising:
a housing having a first portion and a second portion;
a vaping system disposed within the housing, toward the first portion of the housing, wherein the vaping system includes a receptacle formed within the first portion of the housing for receiving a vaping cartridge;
a vibration mechanism disposed within the housing, toward the second portion of the housing;
a power source disposed within the housing and electrically connected to the vibration mechanism and the vaping system, the power source configured to selectively provide power to the vaping system and/or the vibration mechanism,
an outer contact layer disposed about the housing, the outer contact layer configured to cover the housing; and
a cap removably connected to the first portion of the housing, adjacent the vaping system, the cap configured to allow access to the cartridge receptacle formed within the vaping system,
wherein the vibration mechanism and the vaping system are configured to operate independently or simultaneously.

2. The device of claim 1, wherein the power source is a rechargeable battery.

3. The device of claim 1, further comprising an inner support structure within the housing, the inner support structure having a charging port configured to provide external power to the power source.

4. The device of claim 3, wherein the charging port comprises a magnet to attach a USB-B charging cable.

5. The device of claim 1, wherein the vaping system comprises one or more threads formed on an inner surface thereof and is configured to receive threaded vaping cartridges.

6. The device of claim 1, wherein the vaping system is configured to have a low, medium, and high power setting when operated.

7. The device of claim 1, wherein the vibration mechanism is configured to have a plurality of vibration settings when operated.

8. The device of claim 1, wherein the outer contact layer is made of flexible silicon.

9. The device of claim 1, wherein the vibration mechanism and the vaping system are controlled by electrically isolated control buttons so the vibration mechanism can be operated independently or simultaneously with the vaping system.
